(19) United States
(12) Patent Application Publication
(10) Pub. No.: US 2016/0092987 A1
(43) Pub. Date: Mar. 31, 2016

(54) Funding Seed Investments

(71) Applicant: Seedchange Inc., San Francisco, CA (US)

(72) Inventors: Kevin Smith, Burlingame, CA (US); Nathan L. Phillips, San Francisco, CA (US)

(21) Appl. No.: 14/495,885

(22) Filed: Sep. 25, 2014

(51) Int. Cl. G06Q 40/06

(52) U.S. Cl. CPC G06Q 40/06

(57) ABSTRACT

A funding platform permits investors to review a company for investment and provide funding for the company by executing an investment transaction online. The funding platform determines whether the investor is an accredited or qualified investor and provides diligence information to the investor for evaluating whether to invest in the company. The investor provides a request to invest in the company, and the funding platform determines whether the investor has an account with a broker-dealer. The funding platform receives a commitment from the investor to fund the company, and when a funding threshold amount is reached from one or more investors, the funding platform initiates funding of the company and receives a financial instrument for the investors issued by the company.

### BACKGROUND

This invention relates generally to private company investments and in particular to platforms for providing qualified investors with diligence and analyses of early stage private companies and efficiently aggregating funding using automated processes and standardized documentation, including investment documents.

Historically, it has been virtually impossible for investors to obtain regular access to opportunities to invest in high-quality early-stage companies. Early-stage companies are generally small and not well publicized and as a result raising capital for these companies is a difficult and time-consuming process. While early-stage companies are sometimes funded by a “friends and family” round or by angel investors, raising funding from a variety of sources to meet a significant funding target remains a slow, paper-based and inefficient process. At the same time, investors who would like to provide funding are similarly forced to devote extensive time and attention to identifying promising early-stage companies and to diligencing and analyzing them.

### SUMMARY

An online funding platform offers vetted investment opportunities, analyses and evaluations of companies and aggregated funding by pre-screened investors. The funding platform obtains diligence information about an early stage company, such as overview of the company's business strategy and business model, legal analyses of the company's organization and capitalization, operational summary, market analyses, financials and revenue projections, product and technology analyses, extensive interviews with company founders, and analyst projections. Diligence information and analyses are provided by the issuing company as well as from independent research and analysis by analysts of the online investment platform.

Individual investors may invest in the seed company through the online funding platform. The funding platform determines whether an investor is qualified to invest in the seed companies and whether such investments are suitable for specified investors. A qualified investor is an investor permitted by applicable securities laws, rules and regulations to purchase particular types of investments—in this case investments in one or more early stage companies. After confirming that an investor is a qualified investor, the platform provides access to the platform for that investor to review diligence information and analyses of early stage companies listed on the platform. Investors may also make investments directly into each company listed on the platform. The funding platform determines whether the investor is registered with a broker-dealer, and if not yet registered, the funding platform directs the investor to register prior to making an investment commitment. A user registered with the broker-dealer and identified as a qualified investor is permitted to commit funding online. At the time of fund commitment, an investor is re-verified as a qualified investor.

When the amount of funding committed by investors to a company reaches a funding threshold, the funding platform automatically initiates closing on all commitments and initiates execution of the investment agreement and transfer of investor funds to the company in return for a security, such as a convertible note or stock issued by the company. An online funding platform thus permits investors to efficiently find and review vetted and diligenced private companies and to invest directly in the company.

### BRIEF DESCRIPTION OF THE DRAWINGS

FIG. 1 shows an environment for a funding platform that facilitates investment in early-stage companies.

FIG. 2 shows components of the funding platform 100 according to one embodiment.

FIG. 3 shows a flowchart for funding a seed company 120 according to one embodiment.

FIGS. 4 and 5 show example interfaces for displaying diligence information for a particular seed company.

FIG. 6 shows an investment interface provided to an investor for providing an investment commitment to the seed company.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

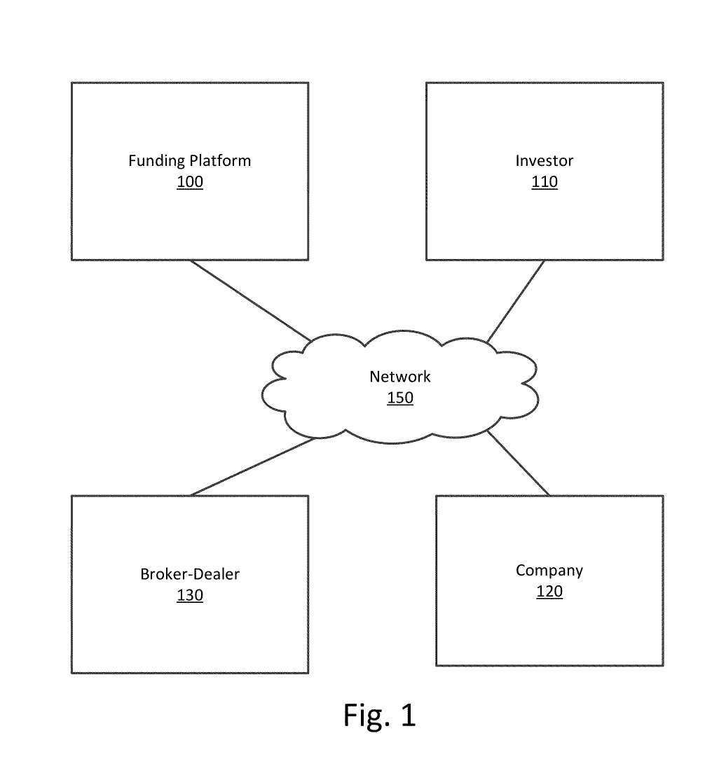

FIG. 1 shows an environment for a funding platform that facilitates investment in private companies. The environment includes a funding platform 100, an investor 110, an early-stage company 120, and a broker-dealer 130. The funding platform 100 obtains and evaluates diligence information about the company 120 and solicits investments from the investor 100 to complete a funding round for the company 120. Prior to permitting funding by the investor 110, the funding platform 100 verifies that the investor 110 is qualified to invest in the company 120. In particular, the investor 110 is required to demonstrate that the investor meets legal, regulatory, and business requirements for investing in the company 120. An individual investor meeting these requirements is an accredited investor. The specific legal and regulatory requirements for qualifying an investor may vary with the legal and regulatory environments. In one environment, accreditation for an investor is based on the investor's net worth or income and an accredited investor must have the ability to bear complete loss of his/her investment in a private company and (a) income of at least $200,000 (alone) or $300,000 (joint with spouse) with an expectation of maintaining or increasing income, or (b) approximate minimum net worth of $1,000,000. A qualified investor is an individual or family-owned business with at least $5 million in assets or an institution with discretion over at least $25 million in assets.

The investor 100 maintains an account with the broker-dealer 130. When investors commit funds to the company 120, the funding platform 100 initiates the funding through broker-dealer 130, which processes the transaction between the investor 110 and the company. For convenience below, the environment is sometimes described with respect to a single investor, private company, and broker-dealer, though many investors and many companies may be serviced by the funding platform 100. For example, many investors 110 may contribute towards the funding of a single company 120, and each investor 110 may contribute towards the funding of many companies 120.

The company 120 is an early-stage company requesting funding from investors through funding platform 100. These early stage companies are generally relatively small, closely held by the founders, employees and a small number of investors, and have not yet been significantly funded by a venture capital firm or other source of significant investment. However, more established companies can also receive funding via the funding platform 100, including larger enterprises and companies that have already received multiple funding rounds. The company 120 typically interacts with the funding platform 100 using a computing device to receive and provide information to the funding platform 100.

The company 120 identifies and provides diligence information to the funding platform 100, including a target funding amount for the company. The target funding amount describes the amount of funding desired by the company 120 for the funding round performed with the funding platform 100. The company 120 may also provide a threshold funding amount designating a minimum amount of funding at which the company 120 should be funded. This threshold funding amount is typically a portion of the target funding amount, though it may be the same value as the target funding amount. The threshold funding amount may be provided by the company 120 or the funding platform 100 may determine a threshold funding amount. The threshold funding amount may be a percentage of the target funding amount, such as 25, 50, or 75%.

In exchange for the investment in the company 120, the company 120 issues a security to its investors. The security may take several forms, and generally represents a portion of the value of the seed company 120. The security may be an equity position in the seed company, such as newly issued shares of stock of the seed company 120, or may be a convertible note that accrues value until a subsequent funding event occurs, at which point the convertible note may convert into another security, such as stock of the seed company 120.

Investors 110 are either individual persons or qualified purchasers interested in providing funding to the company 120. The investors communicate with the funding platform 100 using a computing device. Investors browse various investment opportunities on the funding platform 100 and receive diligence information and analyses relating to the company 120 to determine whether to commit to funding the company 120. The investor 110 commits to investing in the company 120 and executes documentation provided by the funding platform 100. The investor 110 may also register with broker-dealer 130 to establish an account with broker-dealer 130. The investor also provides information about the investor to funding platform 100 and the broker-dealer 130 to demonstrate eligibility for receiving solicitations about and investing in seed companies. Such information includes an investor's net worth, annual income, expected earnings growth, marital status, investment experience, goals of investment, investment objectives, and risk tolerance, as examples. This information and the investment process for the investor 110 are further described below with reference to the funding platform 100.

The broker-dealer 130 is an entity authorized to transact financial transactions on behalf of another party as well as to transact on behalf of itself The broker-dealer 130 may be operated by the funding platform 100 and may be integrated into the system of funding platform 100 or may be a separate system. The broker-dealer 130 serves as a financial intermediary between the investor 110 and funding in the seed company 120. Prior to funding any company 120, the broker-dealer 130 opens an account for the investor 110. In opening the account, the broker-dealer obtains the information about the investor to determine whether the investor 110 is an accredited or qualified investor.

When opening the account, the broker-dealer 130 requests information from the investor 110 to determine whether the investor 110 is an accredited or qualified investor. This determination by the broker-dealer 130 may be independent or made through verification performed by funding platform 100. In particular, in addition to requesting self-reported information regarding accreditation or qualification requirements, the broker-dealer 130 may evaluate suitability of this type of investment by requesting the investor's 110 goals for investments made with the broker-dealer 130, investment objectives and time horizon, financial investment experience, desired degree of risk, and experience with other products that require investor accreditation. When the investor 110 provides this information to the broker-dealer 130, an operator of the broker-dealer (e.g., a principal of the broker-dealer entity) verifies that the investor meets the accreditation status and permits the opening of the account.

The broker-dealer 130 notifies the funding platform 100 that an investor 110 has an account with the broker-dealer 130. In addition, the broker-dealer 130 receives instructions from the funding platform 100 to proceed with funding the company 120, and the broker-dealer 130 facilitates transfer of funds of the investor 110 to the company 120 in exchange for a security according to an investment agreement between the investor 110 and the company 120 facilitated by the funding platform 100. When the broker-dealer 130 is integrated with funding platform 100, these steps may be performed automatically.

The various systems shown in the environment of FIG. 1 communicate via the network 150, which may comprise any combination of local area and/or wide area networks, using both wired and/or wireless communication systems. In one embodiment, the network 150 uses standard communications technologies and/or protocols. For example, the network 150 includes communication links using technologies such as Ethernet, 802.11, worldwide interoperability for microwave access (WiMAX), 3G, 4G, code division multiple access (CDMA), digital subscriber line (DSL), etc. Examples of networking protocols used for communicating via the network 120 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 120 may be represented using any suitable format, such as hypertext markup language (HTML) or extensible markup language (XML). In some embodiments, all or some of the communication links of the network 120 may be encrypted using any suitable technique or techniques.

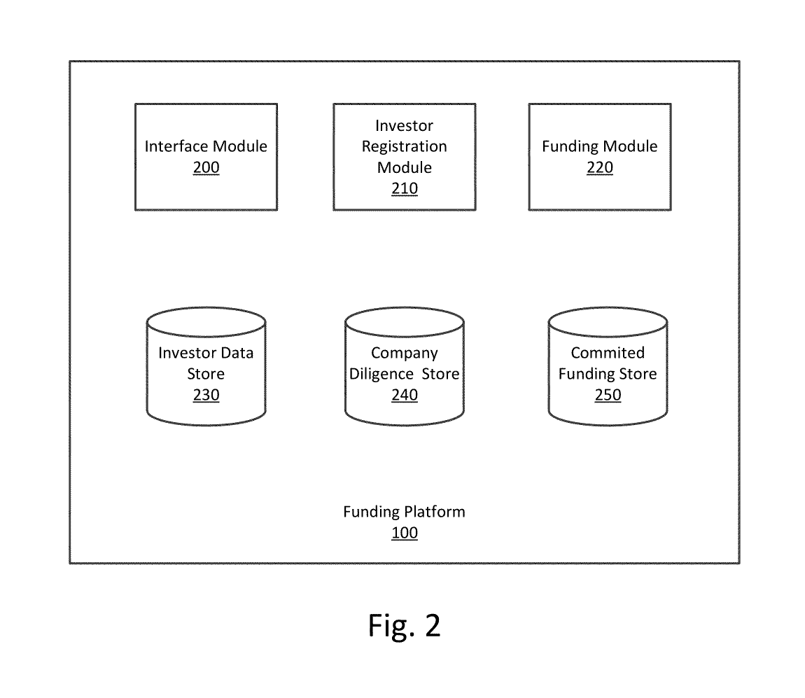

FIG. 2 shows components of the funding platform 100 according to one embodiment. The components of the funding platform 100 include an interface module 200, investor registration module 210, and funding module 220. The funding platform 100 also includes an investor data store 230, company diligence store 240, and committed funding store 250.

The various data stores store, maintain, provide, and update information for the funding platform 100. The investor data store 230 maintains data associated with particular investors 110. Such data for particular investors includes account information, such as an investor's name, address, contact information, and other information about an investor. The investor data store 230 may also maintain the investor's responses to questions relating to the investor's accreditation or qualification, and whether the investor is an accredited or qualified investor. The committed funding store 250 maintains records of committed funding that has not yet been disbursed to companies. This committed funding indicates investors who are willing to invest and who have committed to investing, but the cumulative funding has not yet reached the investment threshold for disbursement to the company 120.

The company diligence store 240 maintains diligence and analysis information for companies describing the company and the investment opportunity that it presents. The diligence and analysis information is typically provided by a combination of the company and by analysts of the funding platform 100. The diligence information also describes a funding threshold and a funding target. The funding threshold indicates the minimum amount of funding for the company prior to disbursing funds for the company, while the funding target describes the total amount of funding that the company is seeking. The diligence and analysis information about the company 120 stored by company diligence store 240 may include many types of information about the seed company. The types of information stored by company diligence store 240 may differ for various seed companies, as certain diligence may be provided by some companies and not by others. These types of information include the following:
Investment Overview: an executive summary of the investment opportunity.
Achievements and Targets: the company's milestones and achievements, including mid-term objectives and goals.
Videos: These videos may include an analysis video by an analyst of the funding platform 100 describing the investment, an overview video by the management team of the seed company 120, and a video interview with members of the founding team.
Product Description: A description of the company's product, user feedback of the product, and value proposition.
Financial Statements and Pricing Model: The seed company's financials and pricing model, including current and future expected revenue streams.
Product Roadmap: The expected development of the product, including features and changes in its value proposition.
Market Summary: An analysis of the market targeted by the company, including size, target customers, and demographic profiles.
Competition: A listing of top competitors of and differentiators between the competitors and the company.
Concrete Milestones to-date: A verified analysis of company development, including product process, partnership agreements, and revenue statements.
Sales & Business Development Plan: A customer acquisition strategy and distribution channels.
Use of Funds: A description of how the company intends to use the investment.
Team Biographies: Biographies of the seed company founders and important team members.
Corporate Documents: Corporate Organization, Stock Issuances, Significant Agreements, and other legal materials.
Capitalization Table: A table of equity in the company held by various stakeholders.
Advisor Statements of Support: Statements supporting the seed company from advisors working with the seed company.
Intellectual Property and Technical Stack Summary: A review and overview of IP and a description of the technical product flow, which may include technical programming profiles of development team members.
Challenges/Risk Factors: A list of risks and likely challenges to be overcome by the company.
Investor Presentation: A company presentation used by the company to introduce the company and solicit funding.

The interface module 200 provides an interface between the funding platform 100 and the network 140. The interface module 200 may also provide instructions for a user interface to be displayed at computing devices operated by the investor 110, the company 120, and broker-dealer 130. The interface module 200 also receives inputs from the network 140 and routes these inputs to the appropriate modules of the funding system 100. When an investor 110 initially accesses the interface module 200, the interface module 200 determines whether the investor has registered with the funding platform 100 by requesting log-in credentials from the investor 110. Investors 110 that successfully log in are directed to the funding module 220 to receive an interface for selecting a company to review for diligence, while investors 110 that are not associated with an account are directed to the investor registration module 210 to establish an account with funding platform 100.

When a new investor 110 accesses the investor registration module 210, the investor registration module 210 registers the investor and requests information from the investor to determine whether the investor is an accredited or qualified investor and eligible to invest in a seed company 120. The investor registration module 210 creates a new account for an investor in the investor data store 230 and requests information from the investor 110 to determine whether the investor 110 is an accredited investor. In the embodiment where an investor is accredited or qualified based on income or net worth, as described above, the investor registration module 210 requests this information from the investor 110. In one embodiment, the investor registration module 210 requests whether a user's income is less than 200 k, between 200 and 300 k, or above 300 k. The investor registration module 210 may further request whether the investor's net worth is above $1M, whether the investor can sustain a loss of all principal provided in funding companies through the funding platform 100, whether the investor's income is estimated to stay the same or increase, and whether the investor's income is calculated as including a spouse. A response to this request is received from a computing device operated by the investor 110 and the user's responses are stored in the investor data store 230. The investor registration module determines whether the investor is an accredited or qualified investor based on the response and the requirements for an accredited or qualified investor. When the investor meets or exceeds the required net worth and income thresholds (among others), the investor is considered accredited for viewing investments at the funding platform 100. Prior to investing in any companies, the investor may also be required to successfully open an account with a broker-dealer, as described above.

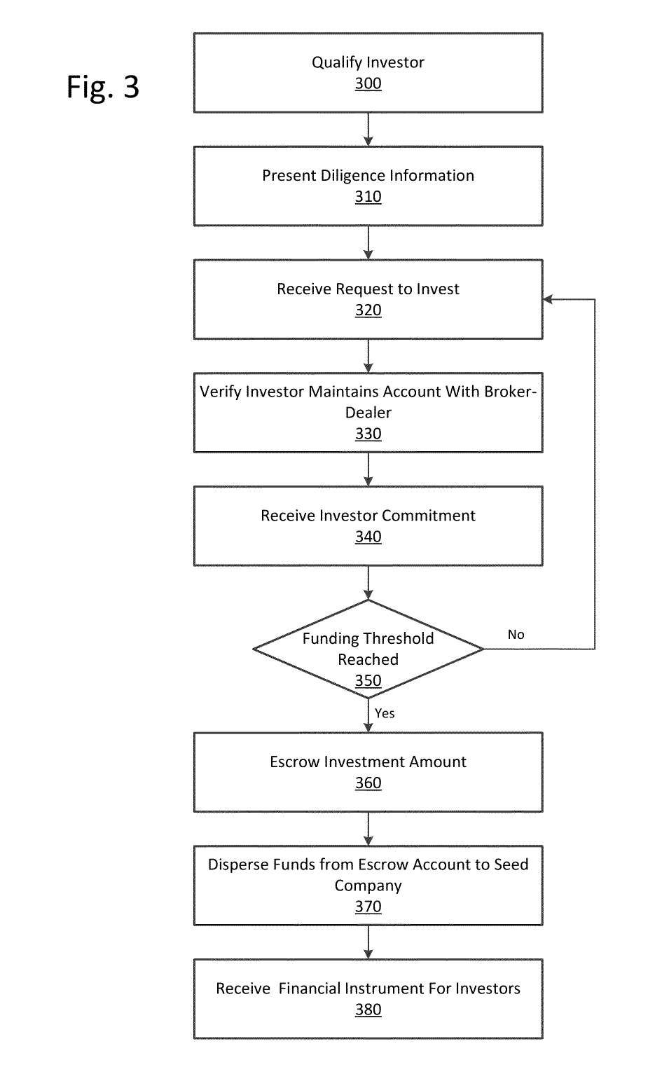

After investor registration, the investor registration module 210 passes the investor to the funding module 220 to identify companies for investment, review diligence information, and commit funding towards a company. FIG. 3 shows a flowchart for funding a company 120 according to one embodiment. The process shown by the flowchart in FIG. 3 is typically performed by the funding module 220. Initially, the funding module 220 determines whether the user has been qualified 300, and if the user has not been qualified, the user provides qualification information to the user registration module 210 as described above to qualify 300 the investor. When the user is qualified, the funding module 220 proceeds to provide company diligence information to the investor.

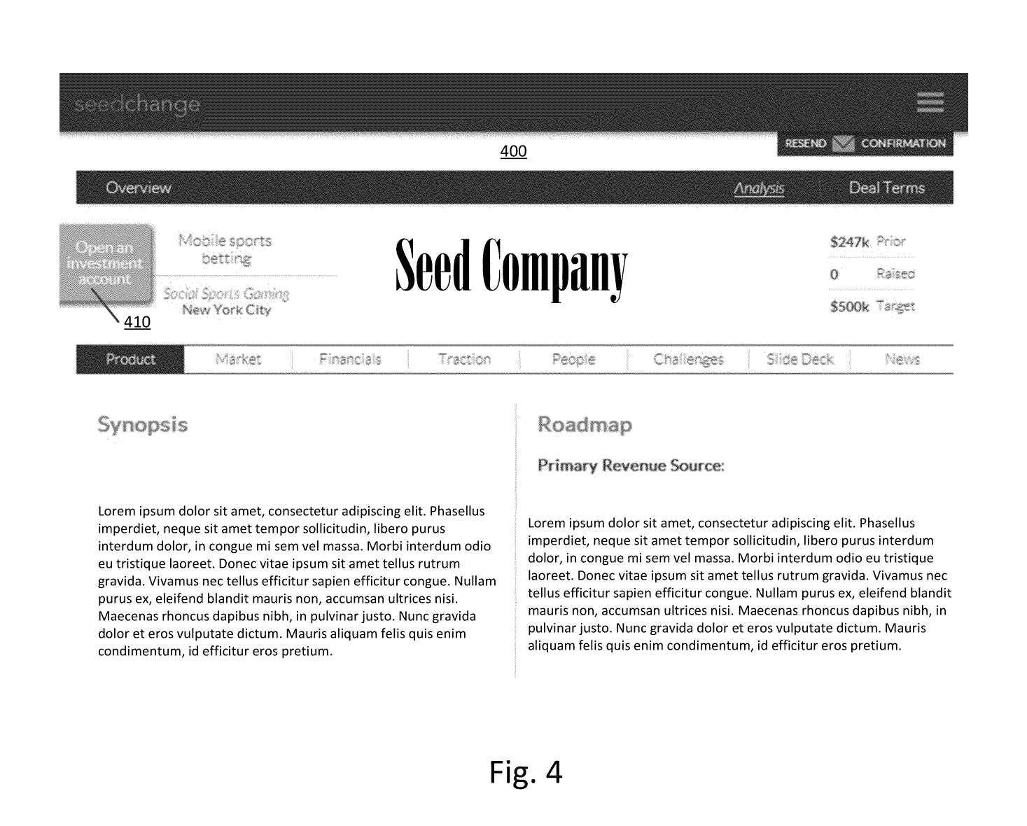

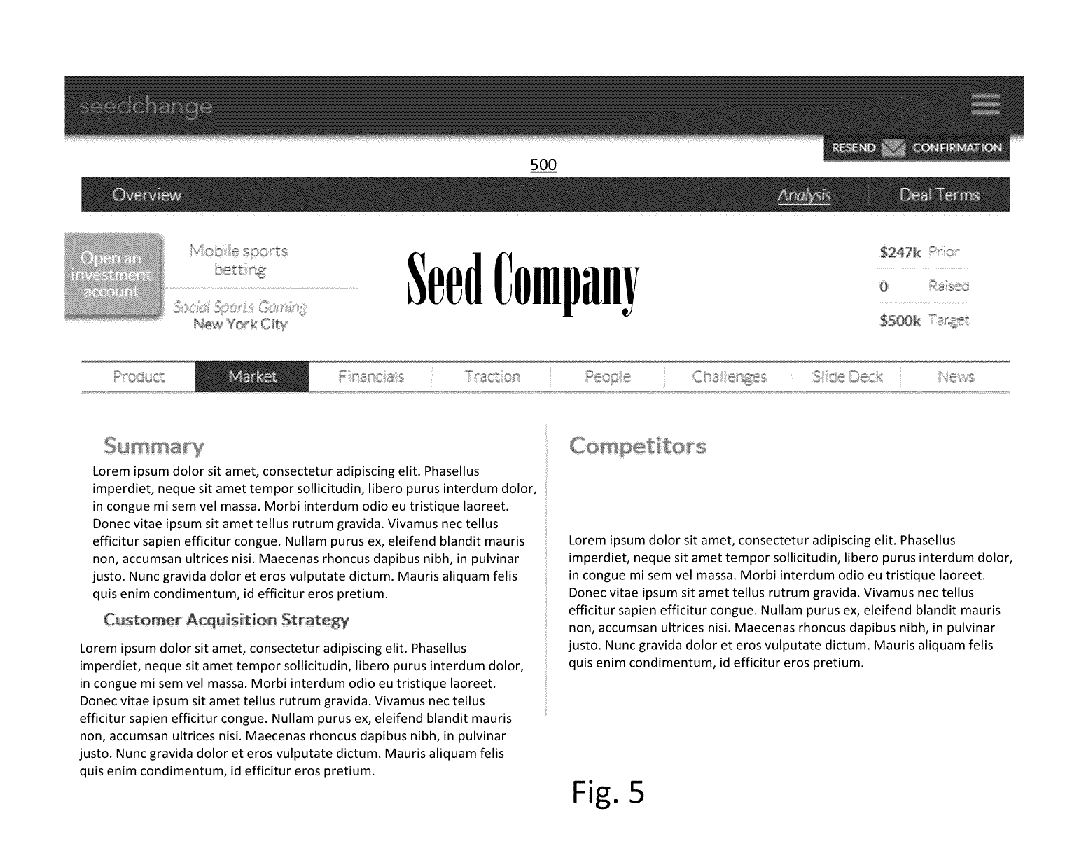

Next, the user is presented 310 with diligence information for companies seeking investment using the platform. FIGS. 4 and 5 show example interfaces 400, 500 for displaying diligence information for a particular company 120. This interface is provided by the funding module 220 to a computing device at the investor 120. The selection and organization of the diligence information may be provided to permit the investor to readily determine whether an investment is likely to be appealing to the investor. FIGS. 4 and 5 show information about a company as organized into various categories, such as product, market, financials, traction, people, challenges, slide deck, and news. The particular categories and types of information for a company may vary based on the type of company and diligence performed. In one embodiment, the company diligence begins with a company overview and next provides information from the founders about the company, including a video and other media by the founders to demonstrate the founders' capability and company direction. Investors may often use the founders' perspective to quickly frame the remaining diligence about the company. The investor 110 may interact with the interface 400, 500, to access additional diligence about the company and determine whether the investor would like to invest.

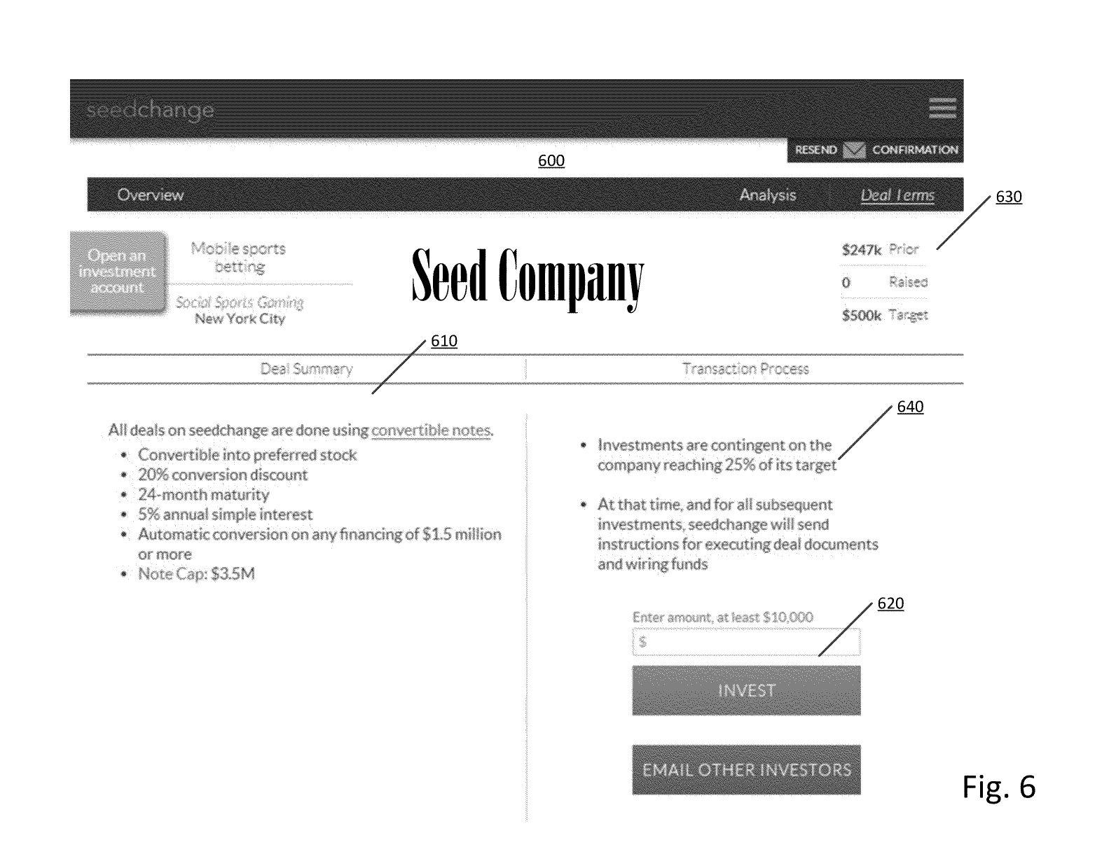

After reviewing the diligence about the company, the investor may view deal terms for investing in the company 120. FIG. 6 shows an investment interface 600 provided to an investor for providing an investment commitment to the seed company 120. The investment interface 600 is provided by the funding module 220 to the computing device operated by investor 110. The investment interface 600 provides investment terms 610 to the investor 110. The particular investment terms may vary across different embodiments, in this embodiment the financial instrument provided by the seed company is a convertible note that accrues interest prior to the conversion. The investment terms for investing across the various companies listed on the funding platform 100 may also be standardized in order to simplify review and authorization by an investor of multiple companies. The investment interface 600 also includes a funding summary 630 showing current funding status of the company, including prior funding of the company, the amount raised by the current funding round at the funding platform 100, and the target funding amount for the current funding round. The investment interface 640 may also display the threshold funding amount for the funding round, which in this example is 25% of the total target funding amount. The investment interface also includes a funding request interface for the investor to enter an investor's desired contribution to the company 130 and provide a request to invest to the funding platform 100.

Returning to FIG. 3, when the investor 110 provides a request to invest via the investment interface 640, the request to invest is received 320 by the funding module 220. Prior to permitting the investor to commit to the investment, the funding module 220 verifies 330 that the investor maintains an account with the broker-dealer 130. When the investor does not yet have an account, the funding module 220 directs the investor to open an account with the broker-dealer 130. As the broker-dealer 130 provides additional verification of the investor's accredited investment status (as described above), the funding platform 100 is provided additional verification that the investor is accredited while maintaining a simple workflow for the investor 110. In addition, in one embodiment the qualification 300 of the investor permits the investor to receive 310 the diligence information prior to verification of the accreditation status through the verification 330 of an account with the broker-dealer. This enables investors 110 to initially view diligence information without providing the more detailed responses required by the broker-dealer for opening an account.

After verifying the investor maintains an account with the broker-dealer, the funding module receives 340 an investor commitment to funding the company 120. The investor commitment is a binding commitment by the investor to fund the company 110 when the total amount of funding for the round has reached or exceeded the threshold funding amount. Typically this commitment is a contract provided to the investor 110 for execution, such as a note purchase agreement. The contract designates the terms at which the investor will contribute to the company and the financial instrument that the investor will receive in exchange. The investor commitment provides an amount to be invested by the investor 110 and may also specify an account from which to draw funds when the investment is to be performed. After receiving 340 the commitment from the investor, the commitment may be stored with an escrow service to safely maintain the contract or other document supporting the commitment by the investor.

After receiving the investor commitment, the funding module 220 determines the total amount of funding commitments for the company 110 and determines whether the threshold funding amount has been reached 350. When the threshold funding amount has not been reached, the funding module 220 awaits another request for investment 320. When the threshold funding amount has been reached, the funding module 220 proceeds to fund the company 120. In this way, prior to funding the company, the funding platform 100 has determined that the investors are accredited or qualified investors, and that the company 120 has received investments of the threshold funding amount and is at least partially towards its funding target.

The funding module 220 notifies investors of the company that the funding threshold has been reached and that the company will be funded. The funding module 220 may wait for the investors to verify that funds are available in the account to fund the investment, or may wait a number of days prior to proceeding with the investments. The funding module 220 in one embodiment may also immediately proceed with the investment. To proceed with the investment, the funding module 220 notifies the broker-dealer 130 of the investment, and instructs the broker-dealer to withdraw funds from the account for an investor and provide the funds to the escrow service 360. In one embodiment, the funds may be withdrawn from the investor's account and provided to the escrow service when the funding commitment has been received from the investor. In one embodiment, the broker-dealer does not receive or hold investor funds, and only provides instructions to the escrow service to fulfill the executed note purchase agreement. The escrow service in one embodiment maintains the funds until the threshold funding amount has been received at the escrow service. After receiving investor funds, the escrow service disperses funds to the company 120 and receives securities issued by the company. When the company 120 is funded, the funding platform 100 may be compensated in a variety of ways. The funding platform 100 may receive a portion of the funding to be provided to the company, a portion of the securities issued by the company, and/or a second security issued by the company.

### Summary

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A method for facilitating investment in a private company, the method comprising:
determining that one or more investors are qualified or accredited investors permitted to invest in the company;
providing diligence information by a funding platform to the one or more investors, the diligence information describing the company;
receiving a request from the one or more investors to commit funding to the company;
verifying, by the funding platform, that the one or more investors are registered with a broker-dealer;
determining whether a total amount of committed funding from a plurality of committed investors, which includes the one or more investors, exceeds a minimum investment threshold for the company; and
responsive to determining that the amount of committed funding exceeds the minimum investment threshold, instructing the broker-dealer to transfer committed funds from one or more accounts associated with the plurality of committed investors to the company and in exchange therefor receive a financial instrument from the company for the benefit of the one or more investors.

2. The method of claim 1, wherein determining that each investor is a qualified or accredited investor is based on at least one of: the investor's income, net worth, and ability to lose principal.

3. The method of claim 1, wherein the diligence information includes at least one of: a video by the founders of the company, achievements of the company, a market summary of the company, competitors of the company, a capitalization table, sales and business development plan, investor pitch deck, or any combination thereof.

4. The method of claim 1, wherein receiving the request to commit funding comprises receiving an executed note purchase or investment agreement.

5. The method of claim 1, wherein the minimum investment threshold is a portion of a target investment level.

6. The method of claim 1, wherein the financial instrument is a convertible note

7. The method of claim 1, wherein the financial instrument is equity in the company.

8. The method of claim 1, further comprising receiving a second financial instrument associated with the amount of the committed funds and retaining the second financial instrument for by an operator of the funding platform.

9. The method of claim 1, wherein a portion of the committed funds is retained by an operator of the funding platform.

10. A computer program product for facilitating investment in a company, the computer program product comprising a computer-readable storage medium containing computer program code for:
determining that one or more investors are qualified or accredited investors permitted to invest in the company;
providing diligence information by a funding platform to the one or more investors, the diligence information describing the company;
receiving a request from the one or more investors to commit funding to the company;
verifying, by the funding platform, that the one or more investors are registered with a broker-dealer;
determining whether a total amount of committed funding from a plurality of committed investors, which includes the one or more investors, exceeds a minimum investment threshold for the company; and
responsive to determining that the amount of committed funding exceeds the minimum investment threshold, instructing the broker-dealer to transfer committed funds from one or more accounts associated with the plurality of committed investors to the company and in exchange therefor receive a financial instrument from the company for the benefit of the one or more investors.

11. The computer program product of claim 10, wherein determining that each investor is a qualified or accredited investor is based on at least one of: the investor's income, net worth, and ability to lose principal.

12. The computer program product of claim 10, wherein the diligence information includes at least one of: a video by the founders of the company, achievements of the company, a market summary of the company, competitors of the company, a capitalization table, sales and business development plan, investor pitch deck, or any combination thereof.

13. The computer program product of claim 10, wherein receiving the request to commit funding comprises receiving an executed note purchase or investment agreement.

14. The computer program product of claim 10, wherein the minimum investment threshold is a portion of a target investment level.

15. The computer program product of claim 10, wherein the financial instrument is a convertible note

16. The computer program product of claim 10, wherein the financial instrument is equity in the company.

17. The computer program product of claim 10, wherein the computer program code is further for receiving a second financial instrument associated with the amount of the committed funds and retaining the second financial instrument for operator of the funding platform.

18. The computer program product of claim 10, wherein a portion of the committed funds is retained by an operator of the funding platform.
